(19) United States
(12) Patent Application Publication
(10) Pub. No.: US 2011/0141878 A1
(43) Pub. Date: Jun. 16, 2011

(54) ACK/NACK TRANSMISSION ON PUCCH IN LTE-ATDD WITH NXPDCCH STRUCTURE

(75) Inventors: Xiang Guang Che, Beijing (CN); Peng Chen, Beijing (CN); Troels Emit Kolding, Klarup (DK); Frank Frederik, Klarup (DK)

(73) Assignee: Nokia Corporation, Espoo (FI)

(21) Appl. No.: 12/934,655

(22) PCT Filed: Mar. 25, 2009
(86) PCT No.: PCT/IB2009/005075

§ 371 Date: Feb. 28, 2011

Related U.S. Application Data
(60) Provisional application No. 61/039,361, filed on Mar. 25, 2008.
(60) Provisional application No. 61/109,143, filed on Oct. 28, 2008.

(51) Int. Cl. H04L 12/26

(52) U.S. Cl. 370/216; 370/241

(57) ABSTRACT

Systems and methods are provided for enabling different “bundling” methods for downlink transmissions and provide different interpretations of the acknowledgement/negative-acknowledgement bit. A user equipment is configured so that it commonly acknowledges all downlink transmission time intervals within a bundle so that if one packet is determined to be erroneous, all packets in that bundle will be retransmitted. Additionally, the systems and methods are implemented by allowing an interpretation to be applied to the uplink acknowledgement/negative-acknowledgement field such that the user equipment is able to divide bundled downlink packets into smaller windows in Long Term Evolution (LTE) Release 8 time division duplex (TDD) mode. In LTE Advanced (LTE-A) TDD mode, various embodiments provide bundling within the time domain, within the frequency domain, and within a hybrid time-frequency domain. Furthermore, enhanced channel selection methods are also provided in support of the above-mentioned bundling methods in accordance with various embodiments.

### FIELD OF THE INVENTION

Various embodiments relate generally to radio communications. More particularly, various embodiments relate to bundling concepts and enhanced channel selection methods in accordance with the Third Generation Partnership Project (3GPP) Long Term Evolution (LTE) Advanced (LTE-A) standardization that are also backwards compatible with bundled ACK/NACK handling, where each ACK/NACK of bundled ACK/NACKS is associated with one downlink packet when the amount of downlink resources is greater than the amount of uplink resources in accordance with the 3GPP LTE Release 8 standard.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Universal Mobile Telecommunications System (UMTS) is a third generation (3G) mobile communication system which provides a variety of multimedia services. The UMTS Terrestrial Radio Access Network (UTRAN) is a part of a UMTS network which includes one or more radio network controllers (RNCs) and one or more nodes. The 3GPP is a collaboration of several independent standardization organizations that is focused on the development of globally applicable 3G mobile phone system specifications. The Technical Specification Group Radio Access Network (TSG RAN) is responsible for the definition of the functions, requirements and interfaces of the universal terrestrial radio access (UTRA) network in its two modes, frequency division duplex (FDD) and time division duplex (TDD). Evolved UTRAN (E-UTRAN), which is also known as LTE, provides new physical layer concepts and protocol architectures for UMTS.

LTE is currently part of a work item phase within the 3GPP that is planned to be ratified as a standard in 3GPP Release 8. One of the central elements of the system is a downlink control channel, which will carry all of the control information needed to assign resources for the downlink as well as the uplink data channels, where downlink and uplink conventionally refer to transmission paths to and from a mobile station and, for example, a base transceiver station. The elements for the control channel carrying allocation for the downlink channel, following the 3GPP 36.211 and 36.213 specifications, can comprise at least: a resource allocation map describing the allocation map for physical resource blocks (PRBs); a modulation scheme/technique; a transport block size or payload size; Hybrid Automatic Repeat-reQuest (H-ARQ) information; multiple-input multiple-output (MIMO) information; and/or a duration of assignment.

LTE supports both a frequency division duplex (FDD) communications mode and a time division duplex (TDD) communications mode. With regard to TDD, information/data/packets may be transmitted over, e.g., the bandwidth of a channel in time multiplexed intervals, referred to as transmission time intervals (TTIs). Due to time multiplexing between downlink and uplink in TDD operation, uplink may have limited resources/time whereas downlink may require a large amount of resources. Conventionally, each downlink packet (transmitted within a TTI) requires one uplink return channel to send back, e.g., an ACK/NACK for Hybrid Automatic Repeat Request (HARQ) operation. For example, in the latest Radio Access Network (RAN)1 decision, ACK/NACK bundling (i.e., an operation of AND over all ACK/NACKs) was accepted to decouple allocated downlink resources from the required uplink return channel capability. That is, a user equipment (UE) only/always sends a one bit (or two bit in case of MIMO) ACK/NACK in the uplink. As a consequence, the coverage/capacity of the uplink ACK/NACK is also decoupled from the required/allocated downlink resources.

In ACK/NACK bundling for the associated downlink transmissions, a UE and evolved node B (eNB) base transceiver station would both need to know how many packets have been transmitted in downlink and that need to be simultaneously (e.g., bundled or AND'ed) ACK/NACK'ed, i.e., sent acknowledgement/negative-acknowledgements. Signaling such information would create a constant signaling overhead for all allocations. Additionally, due to physical downlink control channel (PDCCH) detection errors, a “blind” common understanding between the eNB and the UE cannot be assumed.

Moreover, when a large number of ACK/NACKs for downlink packets are bundled in a bundle/bundling window (where the bundle/bundling window refers to, e.g., the downlink TTI/subframes whose ACK/NACK is to-be-bundled), PDCCH detection reliability, for example, can begin to dominate the link adaptation error target. Hence, a simple AND'ed operation for ACK/NACK bundling becomes unpractical and the eNB must reduce the scheduling flexibility with when, e.g., data packets can be transmitted, such as only allowing one downlink transmission per downlink scheduling window associated with one uplink feedback instance grant. For example, in a 9 downlink/1 uplink scenario, the UE will be reduced to 1/9 of the available system capacity. In an environment with few active users per cell, certain negative implications arise with regard to system performance.

LTE-A will be an evolution of the LTE Release 8 system fulfilling the International Telecommunication Union Radiocommunication Sector (ITU-R) requirements for International Mobile Telecommunications-Advanced (IMT-Advanced) systems. A Study Item on LTE-A was approved by the 3GPP relating to backwards compatibility. Certain assumptions regarding backwards compatibility have been made including the assumption that a Release 8 E-UTRA terminal must be able to work in an Advanced E-UTRAN network, and that an advanced E-UTRA terminal should be able to operate in a Release 8 E-UTRAN network. Therefore, bundling concepts and enhanced channel selection methods applicable to LTE-A should also be backwards compatible with LTE Release 8.

### SUMMARY OF THE INVENTION

Various embodiments allow for determining a type of a received transmission stream and receiving information to use either two ACK/NACK fields or a single ACK/NACK field for the received transmission stream in LTE Release 8 TDD mode. Upon receiving the information to use the two acknowledgement/negative-acknowledgement fields, it is determined whether to divide the transmission stream and send the two acknowledgement/negative-acknowledgement fields for the transmission stream. Dividing bundling windows into smaller subbundles for UEs with sufficient link quality aids in increasing PDCCH reliability while facilitating large data-rate transmissions to each user. Additionally, issues associated with “mixed new and retransmissions” are reduced in cases when a single downlink grant is sent per downlink TTI. Moreover, existing physical uplink control channels (PUCCHs) can be re-used while providing a different interpretation of the ACK/NACK bit in TDD communications mode scenarios when there are more downlink resources than uplink resources. Therefore, PUCCH transmission remains the same as in the FDD communications mode, but higher layer signaling is utilized to change the interpretation of the ACK/NACK bit.

In LTE-A TDD mode, various embodiments provide bundling within the time domain, within the frequency domain, and within a hybrid time-frequency domain. With such methods of bundling in a LTE-A TDD system, the number of ACK/NACKs on the PUCCH can be reduced to 4 or 5 instances. LTE Release 8 TDD mode can support up to 4 ACK/NACKs on the PUCCH. That is, “almost the same” number of ACK/NACKs can be supported on the PUCCH.

Furthermore, enhanced channel selection methods are also provided in support of the above-mentioned bundling methods in accordance with various embodiments. That is, the LTE Release 8 TDD mode method of channel selection is not used in LTE-A TDD mode. Instead, an enhanced TDD channel selection method which ensures backward compatibility with LTE Release 8 is used, where the enhanced TDD channel selection method takes into consideration, These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the invention are described by referring to the attached drawings, in which:

FIG. 1 illustrates uplink ACK/NACK reporting in accordance with FDD communications mode;

FIG. 2 illustrates dividing bundling windows into subbundles for which separate ACK/NACK reporting is provided for each subbundle in accordance with various embodiments;

FIG. 3 is a flow chart illustrating operations performed by a LTE TDD UE configured for bundling in accordance with various embodiments;

FIG. 4 is a graphical representation of channel selection for chunk bundling in accordance with various embodiments;

FIG. 5 is a graphical representation of channel selection for subframe bundling in accordance with various embodiments;

FIG. 6 is a graphical representation of channel selection for block bundling in accordance with various embodiments;

FIG. 7 is flow chart illustrating exemplary processes performed to effectuate ACK/NACK bundling in LTE-A TDD mode in accordance with various embodiments;

FIG. 8 is an overview diagram of a system within which various embodiments of the present invention may be implemented;

FIG. 9 is a perspective view of an electronic device that can be used in conjunction with the implementation of various embodiments of the present invention; and

FIG. 10 is a schematic representation of the circuitry which may be included in the electronic device of FIG. 9.

### DETAILED DESCRIPTION OF THE PREFERRED EMBODIMENTS

Various embodiments described herein enable different “bundling” methods for downlink transmissions and provide different interpretations of the “ACK/NACK” bit in accordance with LTE Release 8. In accordance with various embodiments, the UE is configured so that it commonly acknowledges all downlink TTIs within a bundle so that if one packet is determined to be erroneous, all packets in that bundle will be retransmitted. Additionally, various embodiments are implemented by allowing an interpretation to be applied to the uplink ACK/NACK field such that the eNB is able to decide how to divide bundled downlink packets into smaller windows which allows for a reduced negative impact on PDCCH detection reliability and/or determine how to interpret, e.g., a two bit ACK/NACK. Such a decision(s) is signalled to the UE so that the UE can effectuate the appropriate mapping and subbundle split. It should be noted that various embodiments can be used with UE that have a sufficient uplink link budget to support ACK/NACK reporting for dual-layer transmission. It should also be noted that in the context of transmission streams, e.g., dual-layer transmission, the terms “stream” and “layers” are used interchangeably.

In accordance with one embodiment for use with a FDD UE, two methods of ACK/NACK reporting are utilized. For a FDD UE, there is generally a one-to-one mapping between downlink allocations and uplink ACK/NACK signaling. First, a single ACK/NACK report can be sent by the FDD UE in response to a single-layer transmission in the downlink. Second, a dual ACK/NACK report can be sent corresponding to a dual-stream transmission in the downlink, where each stream of the dual-transmission stream has its own ACK/NACK. That is, one symbol is able to carry ACK/NACK information for a single resource allocation. This resource allocation for FDD can be either a single-stream transmission as noted above, where, e.g., an ACK/NACK symbol will carry one information bit. Alternatively, for dual-stream transmission as noted above, the ACK/NACK symbol will carry the ACK/NACK information for both layers (using, e.g., a modulation similar to quadrature phase shift keying (QPSK)). It should be noted that this ACK/NACK reporting applies to uplink transmission on a PUCCH as well as a physical uplink shared channel (PUSCH). Furthermore, these ACK/NACK reporting methods for the FDD UE are automatically triggered by a downlink grant that informs the UE what transmission mode is active. In the case of the dual-layer transmission, for example, the eNB shifts to a QPSK mode to make room for the two individual ACK/NACKs.

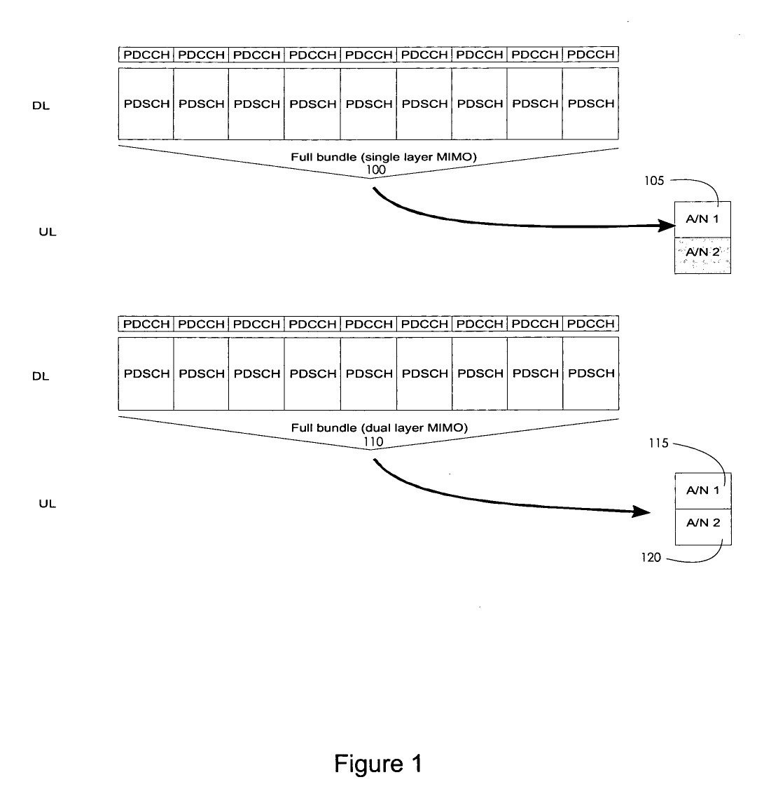

FIG. 1 shows exemplary representations of these ACK/NACK reporting methods for a FDD UE. Physical downlink control channel (PDCCH) and physical downlink shared channel (PDSCH) downlink transmissions that make up a full bundle 100 corresponding to a single-layer multiple input multiple output (MIMO) operation are shown in FIG. 1 with a corresponding single ACK/NACK report 105. PDCCH and PDSCH downlink transmission that make up a full bundle 110 corresponding to a dual-layer MIMO operation are also shown in FIG. 1 with two corresponding ACK/NACKS 115 and 120, one for each layer/stream.

Another embodiment may be utilized in conjunction with a LTE TDD UE that is configured for TTI bundling. In accordance with this embodiment, a layer higher than the physical layer with which physical downlink channels (e.g., PDCCH and PDSCH) are associated can be utilized to inform the LTE TDD UE whether it is to transmit two ACK/NACKS for a corresponding bundle. Such higher layers are, e.g., the Medium Access Control (MAC) layer, Radio Link Control (RLC) layer, etc. Alternatively, the LTE TDD UE can be informed via a downlink grant instead of through the higher layers described above.

In accordance with such an embodiment, the LTE TDD UE performs one of the following operations for each downlink bundling window of TTIs, where each downlink bundling window can include two or more TTIs depending on the particular downlink/uplink configuration. If a relevant downlink transmission comprises a single-stream transmission over all of the bundled TTIs, the LTE TDD UE divides the bundle into two smaller TTI bundles, e.g., subbundles. For each subbundle, one ACK/NACK is sent by the LTE TDD UE. For a dual-stream transmission over all of the bundled TTIs, the LTE TDD UE also divides the TTI bundle into two smaller TTI bundles but will send a joint ACK/NACK for each subbundle separately. Because a joint ACK/NACK is sent for both subbundles representative of each stream, if one stream fails both streams are retransmitted. Alternatively, for the dual-layer transmission over all of the bundled TTIs, the LTE TDD UE can maintain the entire bundling window in a singular format and send separate ACK/NACKs for each of the streams. Therefore, only one multi-stream needs to be transmitted and/or retransmitted.

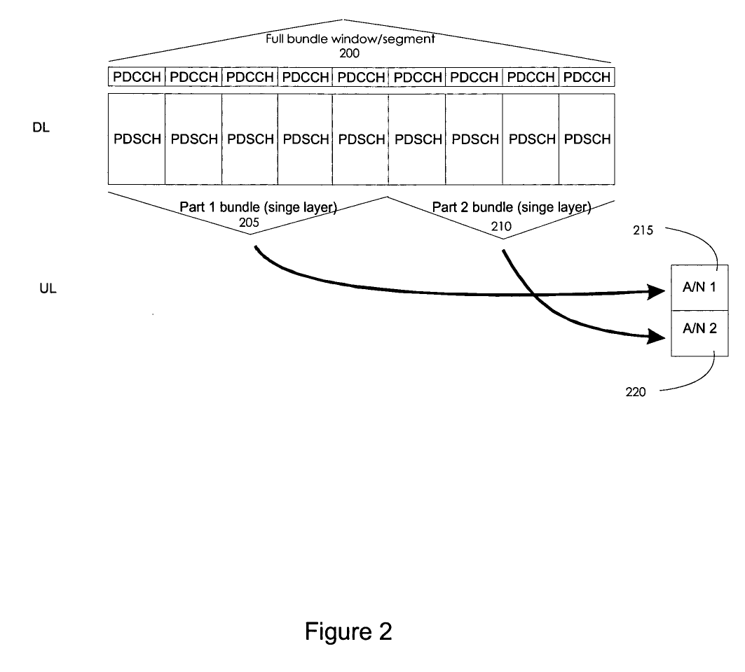

FIG. 2 illustrates an exemplary scenario of TTI bundling for a LTE TDD UE, where a full bundle window or segment 200 is divided into two subparts/subbundles 205 and 210, each of which will have an independent ACK/NACK bit 215 and 220 respectively, sent in response to, e.g., a single-layer transmission.

It should be noted that for simplicity, an eNB can be configured so that it is not able to switch between single and dual-layer transmission within the same bundle. Alternatively, “combinations” of single and dual-layer transmissions can be specified separately indicating how a LTE TDD UE utilizes/exploits its two ACK/NACK bits. For example, all dual-layer allocations from an ACK/NACK perspective, can be mapped to a single-stream and then joint ACK/NACKs can be sent for each subbundle.

The LTE TDD UE is also able to send a single ACK/NACK per bundle in accordance with various embodiments. That is, an option exists for a single-layer transmission over all of the bundled TTIs, where the LTE TDD UE sends a joint ACK/NACK for all downlink subframes. A subframe can be thought of, e.g., as two consecutive slots, where 20 slots can make up a radio frame. Therefore, if there is a reception error of at least either the PDCCH or the PDSCH for a window, everything is retransmitted. If a transmission is a dual-layer transmission over all of the bundled TTIS, the LTE TDD UE sends a joint ACK/NACK for both streams so that if one layer fails, both streams are retransmitted.

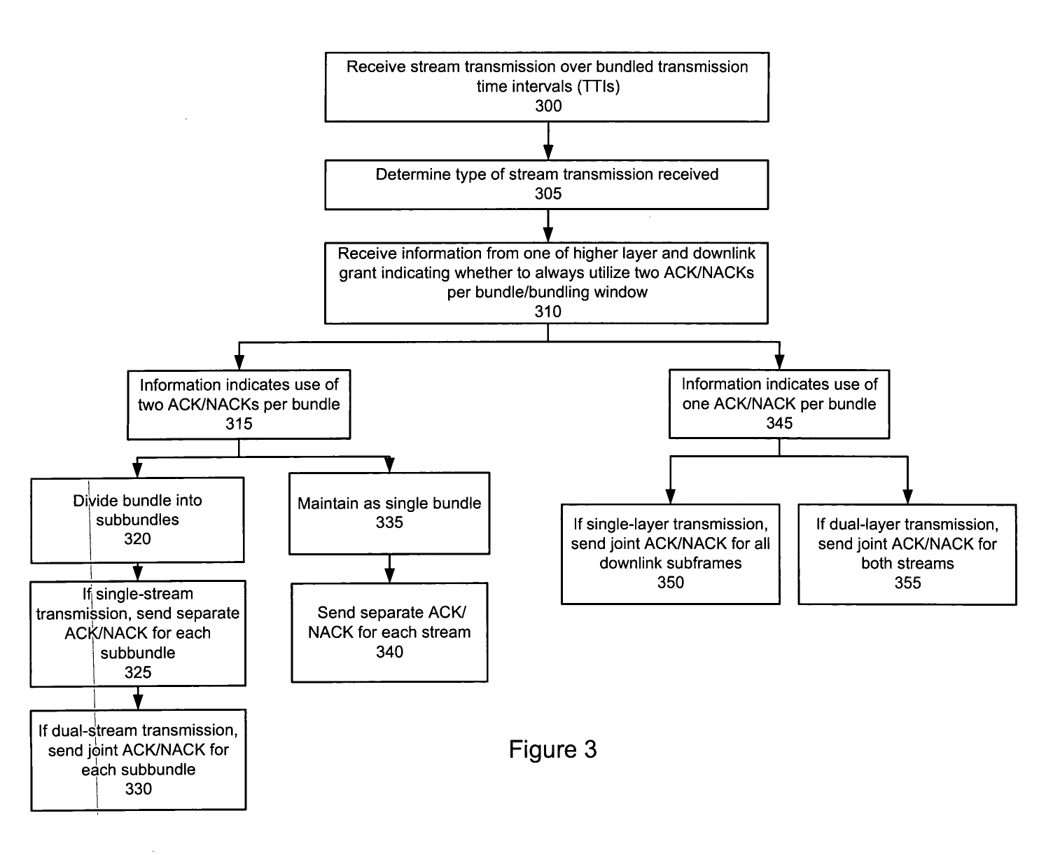

FIG. 3 is a flow chart illustrating operations performed in accordance with various embodiments described herein for providing an alternative interpretation of an uplink ACK/NACK field that allows the UE, upon being informed/signaled by the eNB, to, e.g., divide bundled downlink packets into smaller subbundles/windows when there are more available downlink resources than uplink resources. At 300, a transmission layer/stream over bundled TTIs is received. At 305, the type of transmission layer/stream received is determined, e.g., single-stream transmission or dual-stream transmission. Information from either a higher layer than the physical layer or from a downlink grant is received indicating whether or not to always utilize two ACK/NACKs per bundle at 310. If the received information indicates that two ACK/NACKs are to be used at 315, the bundling window can be divided into subbundles at 320. If the received transmission stream is a single-stream transmission, a separate ACK/NACK is sent for each of the subbundles at 325. If the transmission is a dual-stream transmission, a joint ACK/NACK is sent for each of the subbundles at 330. Alternatively, the bundle/bundling window can be maintained as a single bundle at 335, where a separate ACK/NACK is sent for each stream of the dual-stream transmission at 340. If the received information indicates that one ACK/NACK is to be used per bundle at 345 and if the transmission is a single-layer transmission, a joint ACK/NACK is sent for all downlink subframes at 350. Alternatively, if the transmission is a dual-layer transmission, a joint ACK/NACK is sent for both streams of the dual-layer transmission at 355.

As described above and in accordance with various embodiments, smaller bundle windows can be created for UEs with sufficient link quality, thus increasing PDCCH reliability while facilitating large data-rate transmissions to each user. Additionally, issues associated with “mixed new and retransmissions” are reduced in cases when a single downlink grant is sent for a TTI bundle. Moreover, existing PUCCHs can be re-used while providing a different interpretation of the ACK/NACK bit in TDD communications mode scenarios when there are more downlink resources than uplink resources. Therefore, PUCCH transmission remains the same as in the FDD communications mode, but higher layer signaling is utilized to change the interpretation of the ACK/NACK bit.

In order to meet the aforementioned backwards compatibility requirements, carrier aggregation is being considered as a method to extend bandwidth in a LTE-A system, where channel aggregation can be viewed as a multi-carrier extension of LTE Release 8. From an uplink/downlink control signaling point of view, the most straightforward multi-carrier concept involves copying the existing LTE Release 8 control plane (e.g., PDCCH, PUCCH, etc) to each “chunk.” This concept may be referred to as a N×PDCCH structure in LTE-A. Studies have shown that for UEs having resource allocation in multiple chunks, “per chunk” HARQ is more efficient.

In a LTE-A system and from a PUCCH coverage point of view, single-carrier transmission is desirable whenever possible (to minimize the cubic metric (CM) of the uplink signals). One high-level rule has been proposed to minimize CM properties when ACK/NACKs should be transmitted on the PUCCH in a LTE-A system with a N×PDCCH structure, where if no simultaneous PUSCH is available, uplink control signals are transmitted via a single chunk instead of multiple chunks (i.e., N×DL).

Additionally, to maintain backwards compatibility with LTE Release 8, the method of ACK/NACK multiplexing on the PUCCH in LTE Release 8 TDD (i.e., channel selection on the PUCCH format 1a/1b) should also be extended to LTE-A TDD to support the transmission of ACK/NACK on the PUCCH as described above in accordance with various embodiments.

However, although per chunk HARQ creates good performance in LTE-A systems with a N×PDCCH structure, more control signaling is required. For example, there should be ACK/NACK feedback/reporting for the transmission in each chunk per subframe. In LTE-A TDD mode, there could be 1, 2, 3, 4, or 9 downlink subframes associated with a single uplink subframe. Therefore, assuming a UE reception bandwidth is set as 5 chunks and spatial bundling has been adopted (as in LTE Release 8), the number of ACK/NACK bits to be transmitted in the uplink subframe may be 5, 10, 15, 20 and 45. Supporting such a dynamic range of numbers of ACK/NACKs on the PUCCH is not desirable both from a channel resource limitation perspective and an ACK/NACK detection performance point of view.

In LTE Release 8 TDD mode, the mapping between the states of multiple ACK/NACKs and the ACK/NACK channel derived from downlink subframes (as well as the constellation point derived from the QPSK constellation) has been defined to support ACK/NACK multiplexing on the PUCCH. However, it should be noted that, in LTE-A TDD mode, multiple chunks may be allocated within one subframe, whereas the LTE Release 8 TDD mode is unconcerned with such allocations. Hence such channel selection methods cannot be adopted in the LTE-A TDD mode directly because an ambiguity between the channel selection and frequency/chunk domain exists, which adversely affects efficient ACK/NAKs transmission on the PUCCH in LTE-A TDD mode. Studies have shown that for UEs having resource allocation in multiple chunks, “per chunk” HARQ is more efficient. Hence, various embodiments operative in a LTE-A TDD mode focus on ACK/NAK transmission on the PUCCH with a N×PDCCH structure.

To enable efficient ACK/NACK transmission on the PUCCH in LTE-A TDD mode with a N×PDCCH structure, further bundling over the subframe/chunk domain is provided in accordance with various embodiments to keep the number of ACK/NACK feedbacks at a reasonable level. Such bundling over the subframe/chunk domain is performed instead of/in addition to the bundled ACK/NACK reporting described in earlier embodiments for each downlink bundling window of TTIs/subbundle in LTE Release 8 TDD mode. Additionally, various embodiments provide support for efficient ACK/NACK transmission on the PUCCH in LTE-A TDD mode.

Thus, various embodiments provide bundling within the time domain, within the frequency domain, and within a hybrid time-frequency domain. With such methods of bundling in a LTE-A TDD system, the number of ACK/NACKs on the PUCCH can be reduced to 4 or 5 instances. LTE Release 8 TDD mode can support up to 4 ACK/NACKs on the PUCCH. That is, “almost the same” number of ACK/NACKs can be supported on the PUCCH. However, it should be noted that in LTE-A TDD mode, these “almost the same” results are based on the bundling methods described herein which ensure backwards compatibility with LTE Release 8 TDD mode, although such methods need not be used in LTE Release 8 TDD mode.

Furthermore, enhanced channel selection methods are also provided in support of the above-mentioned bundling methods. That is, the LTE Release 8 TDD mode method of channel selection is not used in LTE-A TDD mode. Instead, an enhanced TDD channel selection method which ensures backward compatibility with LTE Release 8 is used, where the enhanced TDD channel selection method takes into consideration, the multi-carrier aspects of LTE-A.

In accordance with one embodiment, chunk bundling (i.e., time domain bundling) is performed. That is, ACK/NACK bundling is performed over the entire bandwidth or UE reception bandwidth within one subframe. Each subframe (downlink TTI) generates one ACK/NACK feedback, and the number of ACK/NACK feedbacks is based on the number of associated downlink subframes. When each subframe generates only one ACK/NACK feedback, the number of ACK/NACKs within the entire “scheduling window” is reduced to the number of associated downlink subframes. It should be noted that most if not all of the embodiments described above can be “re-used” because through the use of “chunk bundling,” a multi-carrier case in LTE-A TDD mode becomes a single-carrier case, such as that described above and supported by LTE Release 8 TDD mode.

In accordance with another embodiment, subframe bundling (i.e., frequency domain bundling) is provided. For subframe bundling, ACK/NACK bundling is performed over an entire “scheduling window” within one allocated chunk, where the number of ACK/NACK feedbacks is based on the number of chunks within the whole bandwidth or UE reception bandwidth. That is, within a UE reception bandwidth, each chunk over the entire “scheduling window” only generates one ACK/NAK feedback/report. Therefore, subframe bundling effectively turns a multi-subframe case to a single-subframe case. Moreover, if a “chunk” in LTE-A TDD mode is considered to be a “subframe” in LTE Release 8 TDD mode, various embodiments described above for handling bundling (via ACK/NACK reporting for single-layer and dual-layer transmissions over all bundled TTIs/subframes) can be re-used in LTE-A TDD mode.

In accordance with yet another embodiment, block bundling (i.e., hybrid time-frequency domain bundling) is provided. ACK/NAK bundling over both subframe and chunk domains is performed. One PRB/block consists of several subframes and chunks, and generates one ACK/NACK feedback. The number of ACK/NACKs is based on the number of blocks. This method of block bundling can be considered to be a general case of “chunk bundling” and “subframe bundling.”

In LTE-A TDD mode, to enable efficient ACK/NAK feedback on the PUCCH, channel selection should be derived from both downlink subframes and UE reception bandwidth as described above. Furthermore, constellation point selection can re-use the mapping specified in LTE Release 8 TDD mode. Generally, the selected ACK/NACK channel is denoted as (h(i,j), Q(k)), where i refers to the selected downlink subframe/or control channel element (CCE) number, j refers to a single chunk number used to transmit ACK/NACKs, and k refers to a selected constellation point. For LTE A TDD mode, enhanced channel selection methods corresponding to different ACK/NACK bundling methods are as follows.

In accordance with one embodiment, channels for chunk bundling of ACK/NACK feedback (subframe number i, constellation point number k) are selected based on the mapping specified in LTE Release 8 TDD mode. The chunk number j is selected based on the following methods, including but not limited to, a certain position chunk (e.g., the first or last allocated/detected chunk) within subframe i, or channel status.

In accordance with another embodiment, channels for subframe bundling (chunk number j, constellation point number k) are selected based on the mapping in LTE Release 8 TDD mode, and subframe number i is selected based on a certain position subframe (e.g., the first or last allocated/detected subframe) within chunk j. It should be noted that if a UE reception bandwidth is set to 5 chunks, up to 5 ACK/NACK feedbacks will be generated while the channel selection method supports multiple ACK/NACK feedbacks up to 4. In such a case, more than one CCE per chunk-specific PDCCH can be allocated so that more than one PUCCH ACK/NACK resources are available per chunk. Alternatively, all constellation points in both slots of one PUCCH subframe may be utilized for different ACK/NACK information instead of repeating/hopping the same ACK/NACK in 2 slots of one PUCCH subframe. Alternatively still, some many-to-one mappings of 5-bit ACK/NACK to 20 states (i.e., a type of sub-bundling or ACK/NACK compression between pure multiplexing and pure bundling) can be made to fit into 20 PUCCH ACK/NACK constellation points available from a 5 chunk-specific PDCCH, each having a single dedicated PUCCH ACK/NACK channel and each channel having 4 constellation points, i.e., QPSK modulation.

In accordance with still another embodiment, channels for block bundling: (block number h, constellation point number k) are selected based on the mapping in LTE Release 8 TDD mode. Subframe number i and chunk number j are selected based on either a certain position subframe and chunk (e.g., the first or last allocated/detected subframe/chunk) within block h or on channel status within block h.

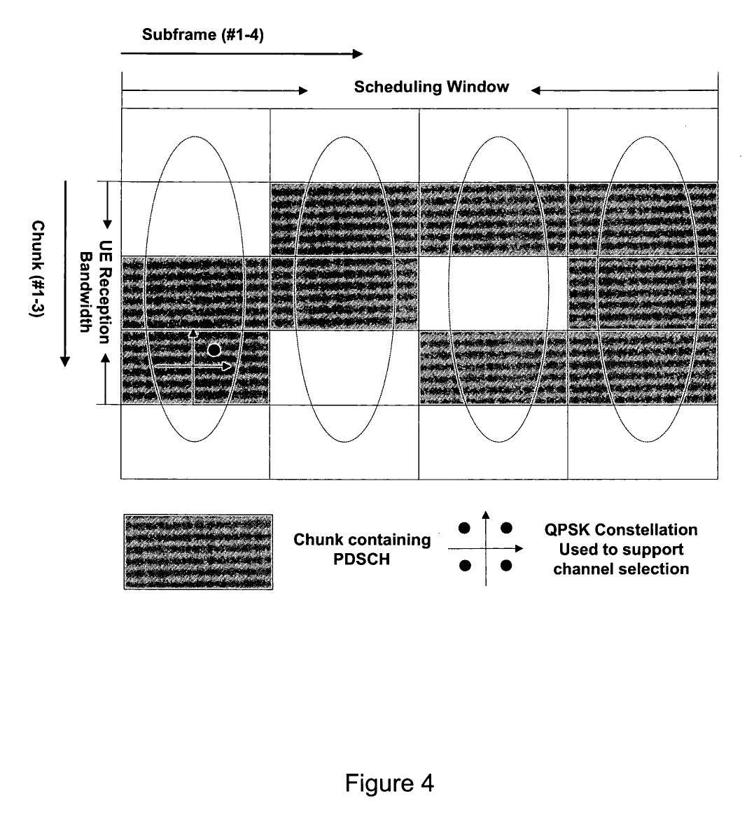

For example, in LTE-A TDD mode, 4 downlink subframes may be associated with 1 uplink subframe, where the UE reception bandwidth is set to 3 chunks. Assuming chunk/subframe/block number and constellation point number (1,1) is selected according to ACK/NAK state and the mapping table as defined in LTE Release 8 TDD mode, exemplary implementations of the bundling methods described above in accordance with various embodiments are described with reference to FIGS. 4-7. It should be noted that in these examples, a 4-bit mapping table in LTE Release 8 TDD is re-used for chunk bundling and block bundling, while a 3-bit mapping table in LTE Release 8 TDD is re-used for subframe bundling.

FIG. 4 illustrates an exemplary instance of channel selection for chunk bundling in accordance with one embodiment. As described above, it can be assumed that the subframe number i and constellation point number k are selected to be (1,1) according to ACK/NACK state and the 4-bit mapping table in LTE Release 8 TDD. It is further assumed that the last allocated/detected chunk within subframe #1 is selected to support channel selection. Hence, as illustrated in FIG. 4, chunk #'s 1-3 are bundled.

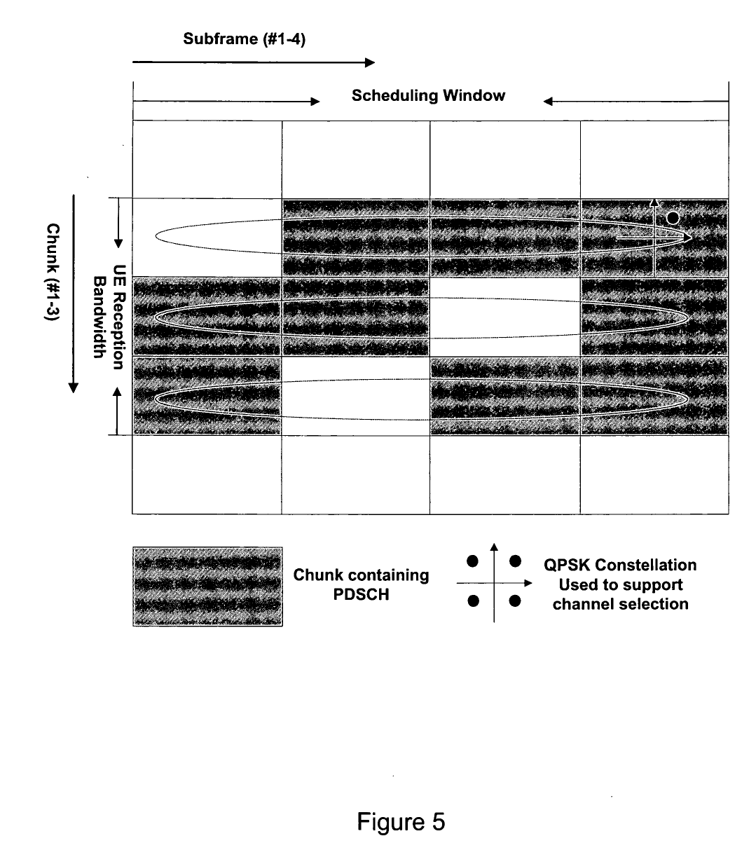

FIG. 5 illustrates an exemplary instance of channel selection for subframe bundling in accordance with another embodiment. As described above, it can be assumed that the chunk number j and constellation point number k are selected to be (1,1) according to ACK/NACK state and the 3-bit mapping table in LTE Release 8. It is further assumed that the last allocated/detected subframe within chunk #1 is selected to support channel selection. Hence, as illustrated in FIG. 5, subframes #'s 1-4 are bundled.

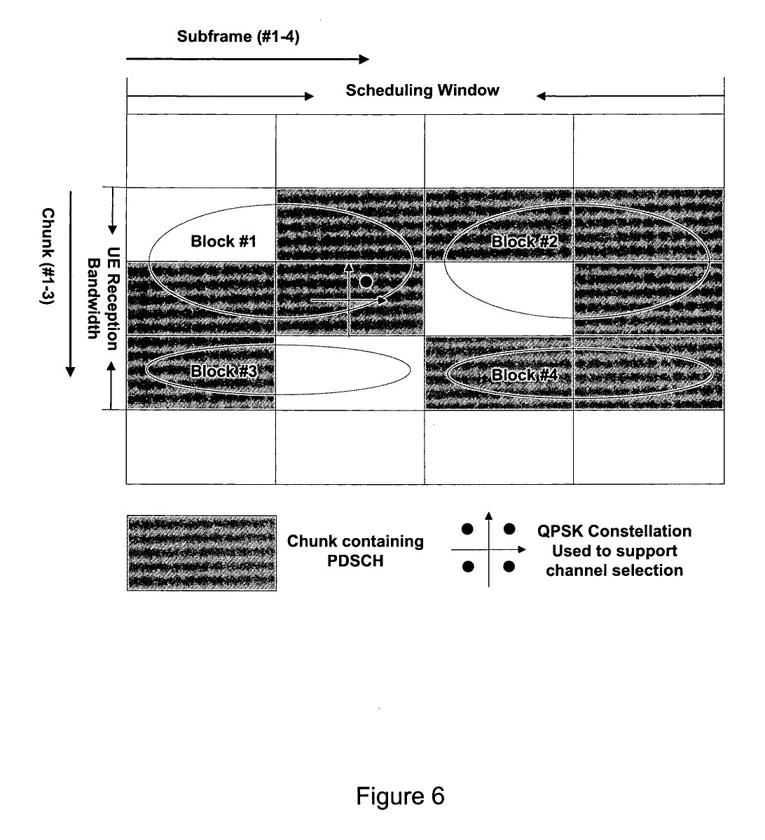

FIG. 6 illustrates an exemplary instance of channel selection for block bundling in accordance with yet another embodiment. As described above, it can be assumed that the block number h and constellation point number k are selected to be (1,1) according to ACK/NACK state and the 4-bit mapping table in LTE Release 8. It is further assumed that the last allocated/detected chunk within subframe #1 is selected to support channel selection. Hence, as illustrated in FIG. 6, block #'s 1-4 are bundled, where block #1 includes chunk #'s 1 and 2 of subframe #'s 1 and 2, block #2 includes chunk #'s 1 and 2 of subframe #'s 3 and 4, block # 3 includes chunk # 3 of subframe #'s 1 and 2, and block # 4 includes chunk # 3 of subframe #'s 3 and 4.

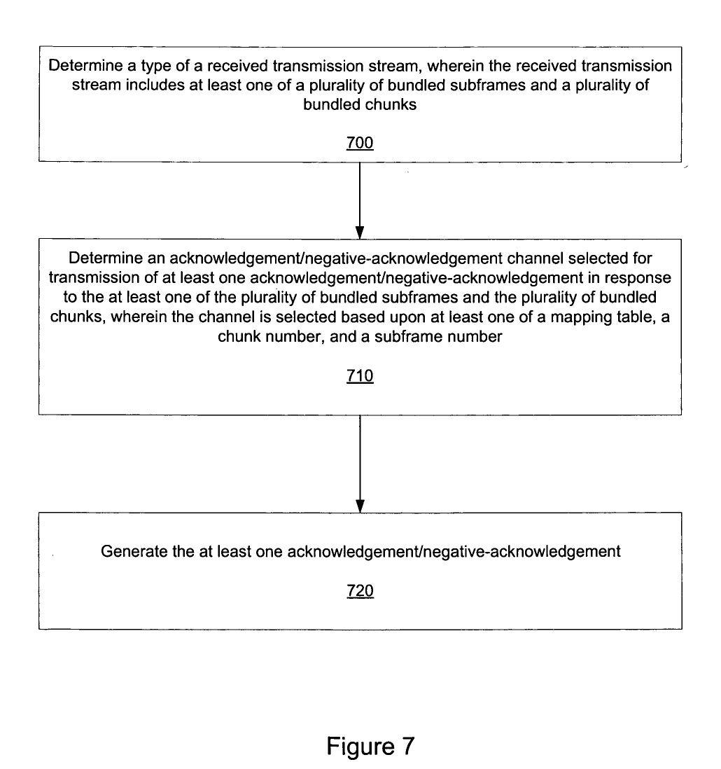

FIG. 7 is a flow chart illustrating exemplary processes performed to effectuate ACK/NACK bundling in LTE-A TDD mode in accordance with various embodiments. At 700, a type of received transmission stream is determined as described above. The transmission stream may be received by a UE from an eNB, where the transmission stream includes at least one of a plurality of bundled subframes and a plurality of bundled chunks. At 710, a selected ACK/NACK channel is determined from the transmission stream, where the selected ACK/NACK channel is for transmission of at least one ACK/NACK in response to at least one of the plurality of bundled subframes and chunks. It should be noted that enhanced channel selection as described above in accordance with various embodiments may be utilized to select the ACK/NACK channel, where selection is based upon at least one of a mapping table (as defined in, e.g., LTE Release 8), a chunk number, and a subframe number. At 720, the at least one ACK/NACK is generated for transmission on a PUCCH.

The ACK/NACK bundling methods of various embodiments described above control the number of ACK/NACK feedbacks by keeping them at a reasonable level. Additionally, an enhanced channel selection method utilized in accordance with the various bundling methods, which is based on time-frequency domain channel selection, takes the multi-carrier property of LTE-A TDD into account. Therefore, efficient ACK/NACK transmission on the PUCCH in LTE-A TDD is supported while remaining fully backwards compatible with bundling methods applicable to LTE Release 8 TDD.

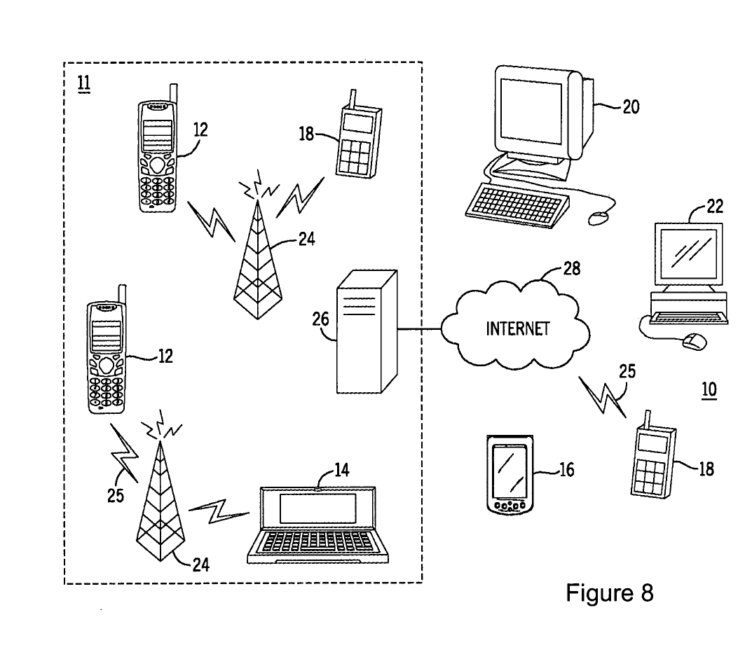

FIG. 8 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 8 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

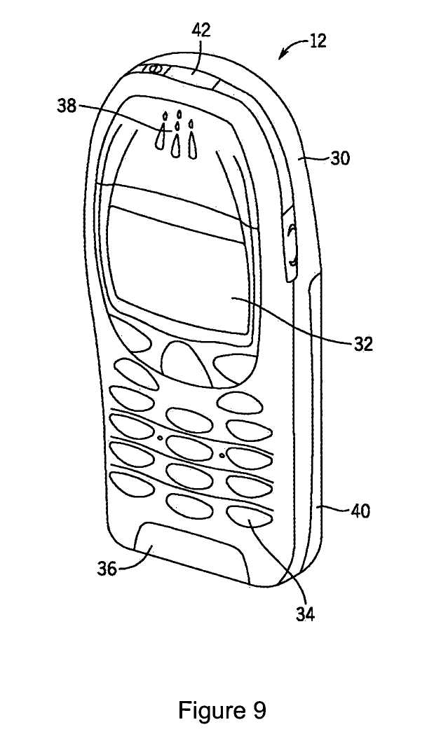

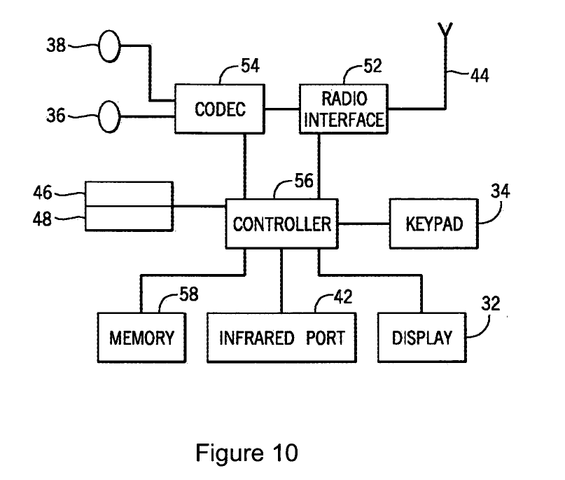

FIGS. 9 and 10 show one representative electronic device 12 within which the present invention may be implemented. It should be understood, however, that the present invention is not intended to be limited to one particular type of device. The electronic device 12 of FIGS. 9 and 10 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as the limiting the scope of the following claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1-48. (canceled)

49. A method of signaling, comprising:
determining a type of a received transmission stream;
receiving information to use one of two acknowledgment/negative-acknowledgment fields and a single acknowledgment/negative-acknowledgment field for the received transmission stream;
upon receiving the information to use the two acknowledgment/negative-acknowledgment fields, determining whether to divide the received transmission stream; and
sending the two acknowledgment/negative-acknowledgment fields for the received transmission stream.

50. The method of claim 49, wherein upon a determination that the received transmission stream is a single-stream transmission, dividing the single-stream transmission into at least two smaller subbundles; and upon a determination that the received transmission stream is a dual-stream transmission, dividing the dual-stream transmission into at least two smaller subbundles.

51. The method of claim 50 further comprising, sending a first and second acknowledgement/negative-acknowledgement field of the two acknowledgement/negative-acknowledgement fields to each subbundle of the at least two smaller subbundles, respectively.

52. The method of claim 51, wherein upon a determination that the received transmission stream is a dual-stream transmission, the first and second acknowledgement/negative-acknowledgement field of the two acknowledgement/negative-acknowledgement fields comprise a joint acknowledgement/negative-acknowledgement field, so that if one transmission stream of the dual-stream transmission fails, the dual-stream transmission is retransmitted in its entirety.

53. The method of claim 49, wherein upon a determination that the received transmission stream is a dual-stream transmission, maintaining the received transmission stream as an undivided dual-stream transmission.

54. The method of claim 53 further comprising, sending a first and second acknowledgement/negative-acknowledgement field of the two acknowledgement/negative-acknowledgement fields separately for each stream of the dual-stream transmission.

55. The method of claim 49, wherein upon a determination that the received transmission stream is a single-stream transmission, and upon a determination to use the single acknowledgement/negative-acknowledgement field, sending the single acknowledgement/negative-acknowledgement field jointly for each downlink subframe of the single-stream transmission.

56. The method of claim 49, wherein upon a determination that the transmission stream is a dual-stream transmission, and upon a determination to use the single acknowledgement/negative-acknowledgement field, sending the single acknowledgement/negative-acknowledgement field jointly for both streams of the dual-stream transmission.

57. The method of claim 49, wherein the received transmission stream is one or more of the following: bundled over a plurality of transmission time intervals; received over a downlink path; received by a time division duplex-capable user equipment; or received from an evolved node B base transceiver station.

58. The method of claim 49, wherein the information is received from a protocol layer higher than a physical layer in a protocol stack of the evolved Universal Mobile Telecommunications System

59. An apparatus, comprising:
a processor configured to:
determine a type of a received transmission stream, wherein the received transmission stream includes at least one of a plurality of bundled subframes and a plurality of bundled chunks;
determine an acknowledgement/negative-acknowledgement channel selected for transmission of at least one acknowledgement/negative-acknowledgement in response to the at least one of the plurality of bundled subframes and the plurality of bundled chunks, wherein the channel is selected based upon at least one of a mapping table, a chunk number, and a subframe number; and
generate the at least one acknowledgement/negative-acknowledgement.

60. The apparatus of claim 59, wherein the transmission of the at least one acknowledgement/negative-acknowledgement occurs over a physical uplink control channel.

61. The apparatus of claim 59, wherein a single acknowledgement/negative-acknowledgement is generated for each subframe of the plurality of bundled subframes.

62. The apparatus of claim 59, wherein the plurality of bundled subframes comprise downlink subframes.

63. The apparatus of claim 59, wherein a single acknowledgement/negative-acknowledgement is generated for each chunk over an entire scheduling window.

64. The apparatus of claim 59, wherein a single acknowledgement/negative-acknowledgement is generated for each block, each block comprising a subset of the plurality of bundled subframes and the plurality of bundled chunks.

65. The apparatus of claim 59, wherein the chunk number is selected based upon one of a position of a chunk within a subframe and channel status.

66. The apparatus of claim 59, wherein the subframe number is selected based upon a position of a subframe within a chunk.

67. The apparatus of claim 59, wherein a combination of the chunk number and the subframe number is selected based upon one of a position of a subframe and a chunk within a block, the block comprising a subset of the plurality of bundled subframes and the plurality of bundled chunks.

68. The apparatus of claim 59, wherein a combination of the chunk number and the subframe number is selected based upon channel status within a block, the block comprising a subset of the plurality of bundled subframes and the plurality of bundled chunks.
